(19) United States
(12) Patent Application Publication
(10) Pub. No.: US 2005/0048273 A1
(43) Pub. Date: Mar. 3, 2005

(54) Reinforced composites and system and method for making same

(76) Inventor: Dale B. Ryan, Mitchel, SD (US)

Correspondence Address: KEVIN A. BUFORD;HOLLAND & KNIGHT LLP, 1600 TYSONS BOULEVARD, SUITE 700, MCLEAN, VA, 22102, US

(21) Appl. No.: 10/892,529

(22) Filed: Jul. 15, 2004

Related U.S. Application Data
(60) Provisional application No. 60/488,269, filed on Jul. 16, 2003.
(60) Provisional application No. 60/511,511, filed on Oct. 15, 2003.
(60) Provisional application No. 60/525,590, filed on Nov. 26, 2003.
(60) Provisional application No. 60/546,525, filed on Feb. 20, 2004.

(51) Int. Cl. B32B 31/00; B29C 71/00

(52) U.S. Cl. 428/297.4; 264/171.13; 264/237; 425/113; 425/114; 156/441; 156/180

(57) ABSTRACT

A detailed embodiment of the invention described herein includes a method and apparatus for pultrusion of a plastic member having a non-wood (e.g., bamboo) reinforced core. The apparatus includes an input and series of die assemblies for taking bamboo tape and embedding it in an appropriately shaped composite member. The die assembly may include a finger die, an encapsulation die, a forming die, and a chilling die. A pultrusion unit maintains production at an efficient and desired rate by use of pressure sensitive clamps to pull the product forward through the prior die units. A colorizer unit and embossing unit allow particular appearances to be produced in the end product. Alternative embodiments are also shown including the processing of bamboo into tape and ribbon forms usable by a pultrusion machine.

### FIELD OF THE INVENTION

The invention in general relates to the field of composite materials, and more particularly to load bearing and other structural materials with bamboo and other non-wood cellulosic cores, and methods to make such cores and composites.

BACKGROUND

For some time now people have been looking for cost-effective substitutes to wood for the manufacture of load-bearing structures. One reason is that the demand is fast outstripping the world's resources in either lower quality “tree farms” or older growth forests. In regions like Asia there are simply not enough trees to satisfy the needs of the burgeoning populations. Another problem with wood, particularly when used outdoors, is the need for regular maintenance and preventive treatments, often with chemicals that are toxic to the environment.

Of the alternatives to wood, metal products like steel or aluminum are well-suited for load-bearing applications. However, metal products cost substantially more than wood ones, making them undesirable as a wood substitute for many applications. Plastics, while they are an effective substitute for wood in many uses, are not suited for load-bearing applications. Composites—a mixture of plastics with other material—an improve the performance of plastics, but the ones with satisfactory strength typically require the use of expensive reinforcing fibers like glass, Kevlar, or carbon.

Many people within the composites industry believe that the availability of a lower-priced core material would lead to an even bigger expansion of the field. The market for carbon-fiber products expands exponentially whenever the cost of the fiber drops. By the same token, other products that might have been considered for composite construction have been forced out when there is too high a cost for the component raw materials. Those same products could, with a reasonably priced reinforcing core material, be very cost competitive. Thus, a low cost reinforcing material could play a key role in expanding the whole composite plastics industry.

One such example of a potential market for expansion of composites is for high-load structures like highway bridges. In the early 1990s the U.S. Department of Transportation proposed an all-plastic bridge structure and cited benefits including minimum (if any), maintenance that would be required once the bridge is installed. Current steel/concrete structures require maintenance within three years of installation and need replacement much sooner than was originally thought. The cost to the federal bridge inventory is enormous and today over 260,000 U.S. bridges are in need of repair or replacement. While several composite bridge demonstration programs have been proposed, all have fallen victims to the cost analysis, with the composite structures being estimated at costing up to five times as much as an equivalent steel and concrete span structure. An inexpensive structural core could dramatically change this formula and, in sufficient quantity, the core cost reduction could make a composite highway bridge quite competitive. Additionally, a lightweight load-carrying beam, column or cross-tie would not be as sensitive to seismic or temperature changes as concrete, and this alone could make such a composite a very desirable replacement for concrete.

Another advantage of a bigger composite industry could come in reducing the number of forests being chopped down to supply man's needs. Take just one example, that of the market for beams and pallets. A typical wood pallet is approximately 40 inches by 48 inches by 5 inches and comprises a plurality of top slats and bottom slats supported on edge oriented 2×4″ timbers. The market for such pallets is several million each year. While this market is a substantial drain on the timber industry, such wood pallets are not a preferred pallet for the food industry. In the food industry, contamination is a problem and efforts have been made to create a sanitizable pallet for re-use. Various efforts have been made to create a plastic pallet but such efforts have been largely unsuccessful for at least two reasons. A first reason is that plastic, as its name implies, will deform in response to load and therefore creates a failure condition when loaded pallets are mounted on edge racks in warehouse storage. A second problem is that plastic is substantially more expensive than wood raising pallet costs by several multiples. Accordingly, it would also be advantageous to provide a further structural substitute or supplement for wood and plastic in the pallet industry.

One promising alternative is disclosed in U.S. Pat. No. 5,876,649, by the same inventor as for the present invention, and incorporated herein by reference for all purposes. This patent discloses the use of bamboo as a reinforcing member for plastic load-bearing products. The advantages of bamboo include its high tensile strength (in the same range as steel alloys), and its availability as a natural product and in quantities that could satisfy the worldwide demand for cost-effective load-bearing products. However, this pioneering work in the use of bamboo only disclosed particular, more labor intensive approaches to making bamboo reinforced products as then appreciated. Before bamboo-reinforced products will become widely available, efficient manufacturing processes are needed that can scale to the level of billions of board-feet annual production.

Just such a solution to the problems noted above and more, are made possible by my invention disclosed here.

### SUMMARY

An illustrative summary of the invention, with particular reference to the detailed embodiment described below, includes a method and apparatus for pultrusion of a plastic member having a non-wood (e.g., bamboo) reinforced core. The apparatus includes an input and series of die assemblies for taking bamboo tape and embedding it in an appropriately shaped composite member. The die assembly may include a finger die, an encapsulation die, a forming die, and a chilling die. A pultrusion unit maintains production at an efficient and desired rate by use of pressure sensitive clamps or caterpillar units to pull the product forward through the prior die units. A colorizer unit and embossing unit allow particular appearances to be produced in the end product.

The process for making a reinforced bamboo product starts with the manufacture of an appropriately shaped bamboo insert. For most applications it is preferable to use a tape or ribbon dispensed from a coil. In a preferred approach bamboo tapes are prepared into a ribbon, and a thin plastic layer is extruded onto and pressed into the bamboo ribbon by rollers, and then cooled and coiled onto spools. The coil-fed mechanism facilitates a smooth and rapid feeding of relatively uniform strips of bamboo into the die assembly of the pultrusion machine.

### THE FIGURES

My invention may be more readily appreciated from the following detailed description, when read in conjunction with the accompanying drawings, in which:

FIGS. 1A-1D are views of bamboo tape preparation devices in accordance with a first embodiment of the invention, in which:

FIG. 1A is a perspective view of traveling sewing machine;

FIG. 1B is a top view of a six-tape stitched ribbon;

FIG. 1C is a perspective view of a bamboo tape dryer;

FIG. 1D is a side view of another embodiment of a bamboo tape encapsulation and ribbon making line;

FIGS. 1E-1G are views of an alternative bamboo tape preparation assembly, in which:

FIG. 1E is a perspective view of the placement table and slitter machine;

FIG. 1F is a front view of a pair of slitters;

FIG. 1G is a side view of the alternative assembly, including die, cooling and rolling units;

FIG. 2A is a top view and FIG. 2B is a right side view of an integrated bamboo lumber production assembly in accordance with a further embodiment of the invention;

FIGS. 3A-3F are perspective views of two embodiments of the intake of the assembly of FIGS. 2A-2B, in which:

FIG. 3A is a side view of a roller box for use with the assembly of FIGS. 2A-AB;

FIG. 3B is a perspective view of a first finger die, and the extruder assembly for the pultrusion line of FIGS. 2A-2B;

FIG. 3C is a perspective view of an in-feed box for the pultrusion line of FIGS. 2A-2B;

FIG. 3D is a side perspective view of an alternative infeed assembly for the pultrusion line of FIGS. 2A-2B;

FIG. 3E is a top view, and FIG. 3F is a side view, of an alternative, preferred finger die assembly for the pultrusion line of FIGS. 2A-2B;

FIGS. 4A-4E are views of the die assemblies of the pultrusion line of FIGS. 2A-2B, in which:

FIG. 4A is a top view of an encapsulation die;

FIG. 4B is a top view of a forming die;

FIG. 4C is a top view of a chilling die;

FIG. 4D is a partial perspective view of the chilling tank;

FIG. 4E is a perspective view of a flip-open die assembly;

FIGS. 5A-5D are views of the pultrusion unit of the line of FIGS. 2A-2B, in which:

FIG. 5A is a perspective view of a pultrusion clamp assembly;

FIG. 5B is a perspective view of a pultrusion clamp;

FIG. 5C is a perspective view of a caterpillar unit;

FIG. 5D is a perspective view of embossing rollers;

FIGS. 6A-6B are perspective and side views, respectively, of a color roller assembly for the pultrusion line of FIGS. 2A-2B; and

FIGS. 7A-7C are cross-sectional views of examples of product embodiments of bamboo lumber, illustrating a rectangular, ellipsoidal, and I-beam plastic lumber product, respectively, as might be made by the pultrusion line of FIGS. 2A-2B, according to the invention.

### DESCRIPTION OF AN EMBODIMENT OF THE INVENTION

A presently preferred embodiment according to my invention includes a method and apparatus for pultrusion of a plastic member having a bamboo-reinforced core. The apparatus includes an input and series of die assemblies for taking bamboo tape and embedding it in an appropriately shaped composite member. A pultrusion and saw assembly maintain production at an efficient and desired rate for the particular shape(s) and type of end product being produced. Alternative embodiments are also shown for the processing of bamboo into tape and ribbon forms usable by a pultrusion machine.

The process for making a reinforced bamboo product starts with the manufacture of an appropriately shaped bamboo insert. For most applications it is preferable to use a tape or ribbon dispensed from a coil, as a coil-fed mechanism facilitates a smooth and rapid feeding of relatively uniform strips of bamboo into the die assembly for making a core. Thus, the process for making plastic lumber typically begins with a tape manufacturing process.

In a first process, bamboo tubes, or culms, are cut and transported to a processing location near the region where the bamboo is grown. These culms can be obtained from any of the various countries that are within the bamboo growth belt, most of which are close to the equator. Processing is best carried out near where the bamboo grows, as the bamboo culms usually process easier when they are green, before they are allowed to dry.

The process of making culms begins by splitting the bamboo manually or by machine into smaller, preferably around ¾″ width and full thickness/length, pieces of culm wall. The resulting split culm is then fed into a tape-producing machine (not shown), which includes plural gears for securely positioning a bamboo culm and pulling it in a substantially uniform manner past a blade such as one would see in a wood plane, which contacts the split and slices off a section of tape. The thickness of the resulting bamboo strip or tape is controlled by the offset of this blade. A presently preferred setting for the tape is approximately 1/16″ of an inch in thickness and ¾″ in width, with a length determined by the culm being fed (i.e., many, up to 80, feet in length). The remainder of the culm is repeatedly processed until all the strips have been cut that are of a usable dimension. The strips are split culm, preferably of a length substantially the same or longer than the final desired load-bearing product, which will typically be in a range of 4′ or greater; shorter split culm lengths could be used when the final strips are joined into tapes or ribbons, e.g., by the sewing process described herein. While certain remnants will not be usable for purposes of making bamboo tape, they can be advantageously used as bamboo chips (i.e., pieces smaller than 3 inches and typically on the order of 1 cm) or pulp in other reinforced composites.

After the strips have been cut to the desired depth and width, the tapes are processed for transportation to the pultrusion assembly. In a first approach, the tapes may be simply dried outdoors, and since tape dries much faster than culm, it may dry in as short as a day compared to two weeks for a typical tube. If the tape is to be transported in strips, it can be formed into cut strips of appropriate lengths, such as 8, 10, or 12 foot or other length, depending on the desired length for the final production. These strips are then bundled up into flat bundles for ease of shipping. This avoids one problem with the shipping of spools, in that spools can continue drying during transportation. This further drying is typically disadvantageous as it can give more permanence to the coiled shape of the spooled bamboo, and leave the bamboo springy and hard to work with at the destination.

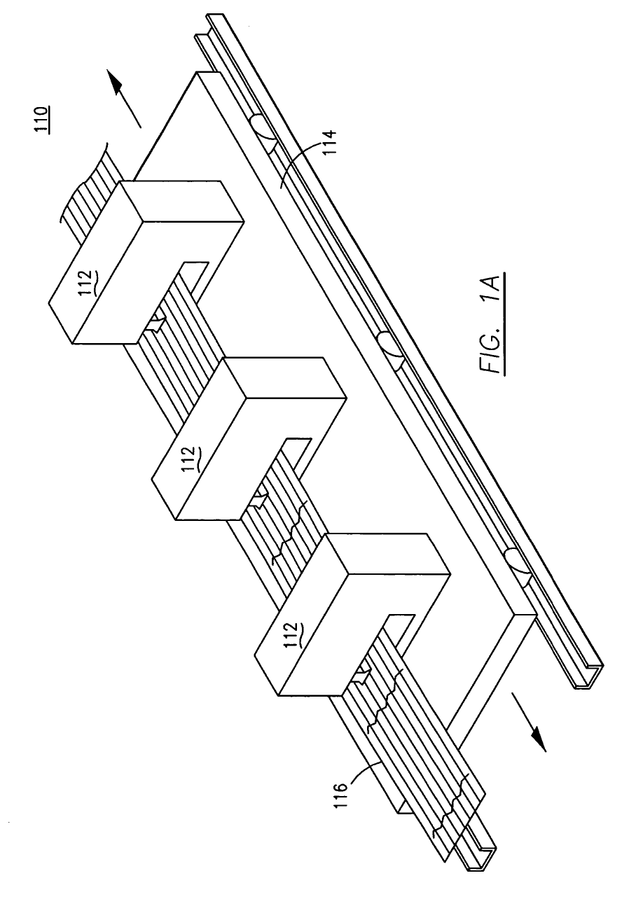

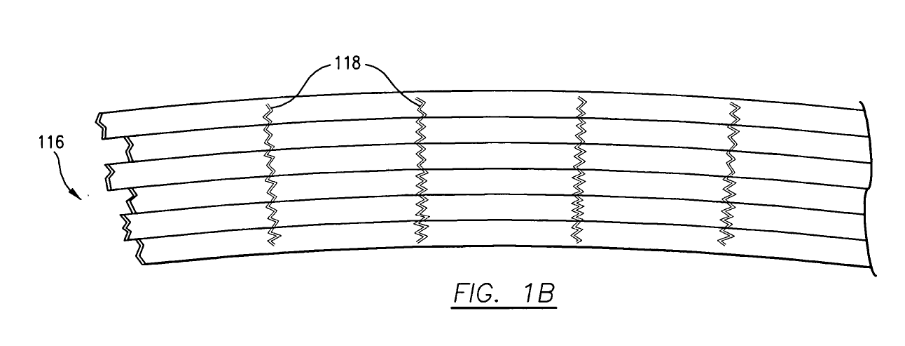

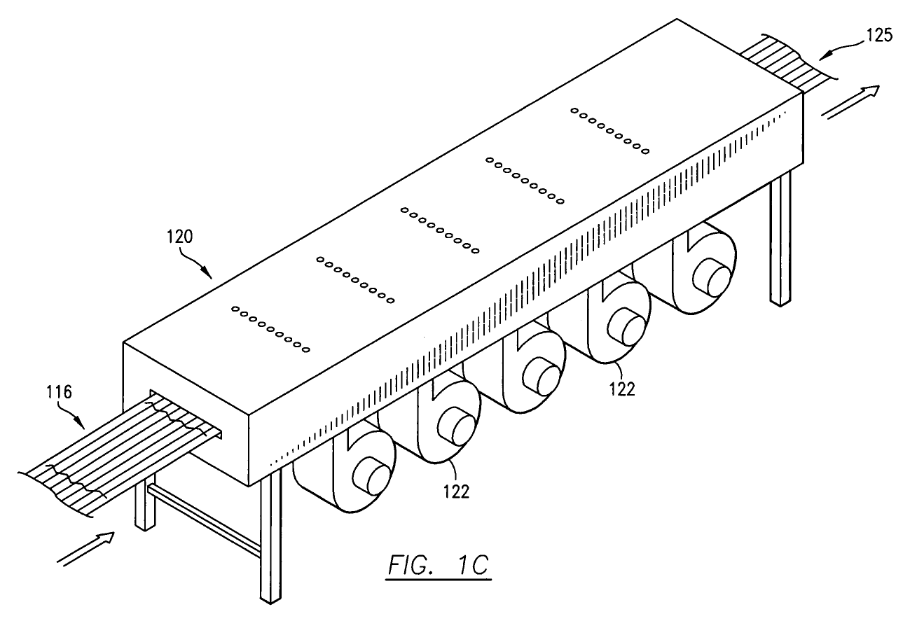

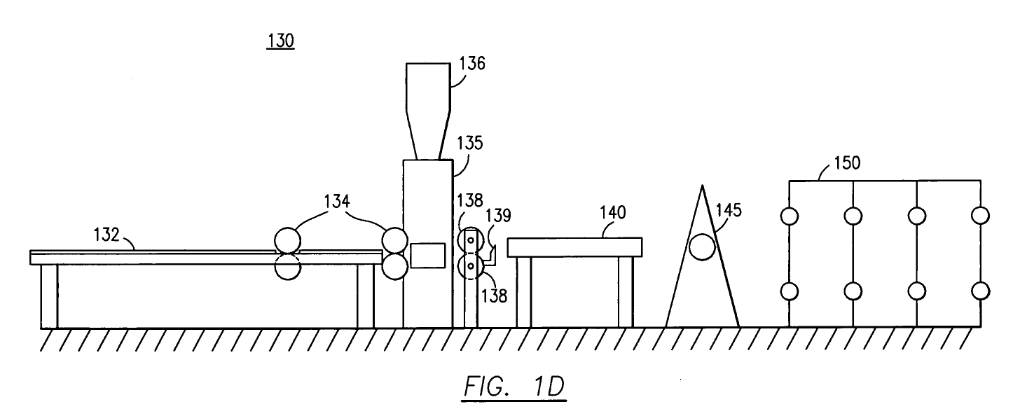

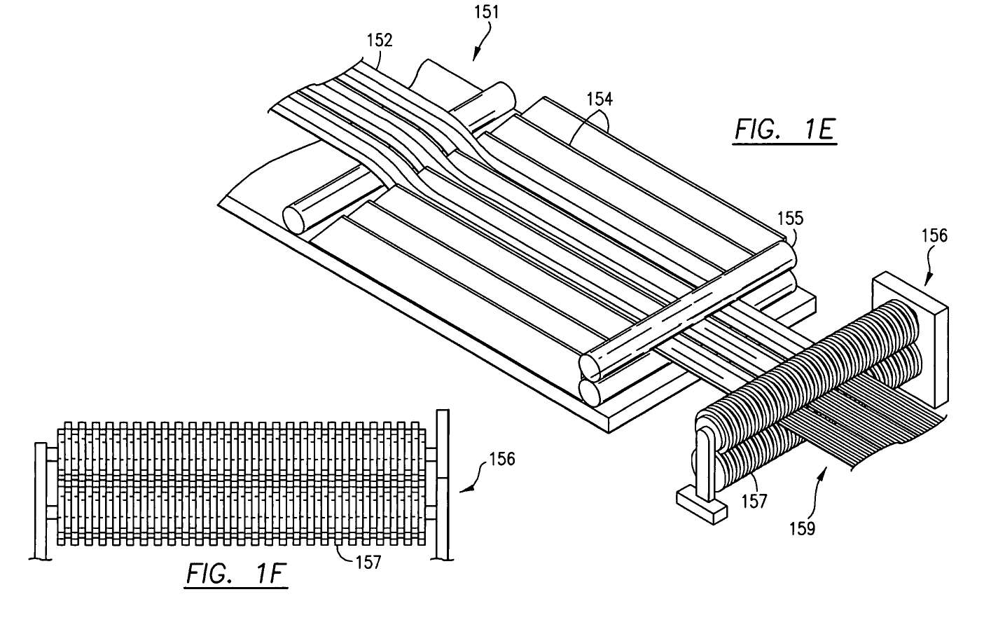

Whether or not the bamboo strips are formed into ribbons at the place of origination, close to where the bamboo is grown, or at the destination, it is typically more cost effective to form the bamboo strips into ribbons before processing in a pultrusion assembly. FIGS. 1A-1B illustrate a first apparatus for making such a bamboo tape ribbon. The bamboo strips are laid in pairs to a desired width, this particular run showing a ribbon 116 made of three pairs of bamboo strips. The strips may be inserted by hand, but are preferably placed into a set of rollers that securely position the strips adjacent to each other and feed the strips through the remainder of the assembly. If the strips are not trimmed on the sides, a substantially uniform width can still be achieved (while minimizing culm waste trimmings) by laying the culms in alternating patterns side by side to form a tape ribbon. In other words, a first strip may be laid down starting with the top of the bamboo (i.e., where it is the narrowest), while the strip next to it is laid starting with the bottom of the culm (i.e., where the culm was the thickest). The strips are then secured together by a traveling sewing or stitching machine 110. The sewing machine 110 may have plural sewing units 112 positioned on a traveling table 114. The table preferably moves at the same velocity as the bamboo strips 116 to allow for a uniform stitching 118 in the strips 116. Alternatively, strips could be bound together using other means, such as a single sewing unit moving back and forth across the advancing strips, in that case making a zigzag pattern in the strips 116. The pattern and types of binding/thread are matters left to the design choice of a skilled artisan, as the purpose of the binder is not critical for subsequent load-bearing characteristics of the plastic lumber, but is rather used to keep a desired orientation of the various strips relative to each other until the tape is formed into a core.

The ribbon may be anywhere from 1 to 10 or more tapes wide, depending on the application. For example, for 2″ by 6″ plastic lumber 6 or 7 tapes may be used, since this lumber typically requires ribbons approximately 5 inches in overall width. Other lumber or product dimensions will require different width ribbons consisting of a sufficient number of tapes to make the correct width. A railroad tie, for example, may have ribbons that are 10 tapes wide, and require as many as 36 layers or more of ribbons. The ribbon will vary, then, both depending on the initial strip dimensions and the desired width and thickness of the final products. When stitched, the ribbon may be a continuous length of bamboo stretching several hundred feet long.

Once the ribbon 116 has been stitched or bound, it is dimensioned by a sizing unit and stored. The sizing unit (not shown) may be as simple as a pair of blades positioned at a desired separation, so the stitched ribbon 116 is trimmed on both sides. This gives the ribbon a uniform width and straight edges. Because the strips are already cut to a substantially uniform depth, the ribbon also has a substantially uniform depth and width. The ribbon 116 may then be stored, preferably on a spool loaded on a winding unit (not shown) that winds the ribbon onto the spool. If the bamboo strips are continuously fed through the sewing/sizing unit, a saw can be used to laterally cut the ribbon 125 when the spool is substantially full. Alternatively, the strips can be monitored as they are being fed into the sewing unit 110 to insure that the feed process is paused when a desired length of ribbon, e.g., enough to fill a spool, has been produced. Because the strips are being stitched together, there is no requirement for strips to be spliced with the immediately preceding or following strips. If the strips are fed so that the ends of side-by-side strips are substantially spaced apart from each other, the lack of splicing will not significantly impair the load-bearing characteristics of plastic lumber in certain applications. In this case, it may prove advantageous to feed adjacent strips so the ends are spaced apart from each other. Where the longitudinal load bearing characteristics are of more concern, each of the strips can be spliced to its following strip by any of the splicing techniques known in the art.

Next, the ribbon is typically dried. One such drying unit 120 is illustrated in FIG. 1C, in which ribbon 116 is fed past one or more hot air blowers 122, to produce an appropriately cured bamboo ribbon 125. The actual amount of drying will depend on how the bamboo ribbon will be used next. The bamboo should preferably be dried to a moisture content so as to achieve a range of approximately 0.5 to 1% in the end product, as the tensile strength of bamboo is typically at a maximum within this range. This will vary, however, depending on factors such as the variety of bamboo being used and sensitivity of certain plastics to moisture. If the ribbon is not going straight into a production facility, but is rather being packaged for transport, a higher moisture content may also be desired. This is particularly true if the ribbon is going to be packaged for ocean transportation, as the higher moisture content helps keep the ribbon from absorbing undesirable salt water moisture. Thus, the moisture content will vary by intended application, and a skilled artisan will understand how to select an appropriate level based on the circumstances. Further, this form of drying unit may be unnecessary if the bamboo is being spooled prior to shipping, particularly if the bamboo has been previously dried while in the culm or tape form, by any of the well-known drying processes used for drying culms or tapes. Even if previously dried before shipping, the ribbon spools are typically readied before being fed into a pultrusion machine by further drying, using a drier 120 as described above or other appropriate drying technique. Thus, e.g., the bamboo ribbon's moisture content, which was left high during transportation to avoid absorption of salt water vapors, can be lowered to a desirable level for optimum tensile strength and adhesion of the plastic and/or binders used in the pultrusion process.

FIG. 1D illustrates yet another way, using ribbon making assembly 130, for processing bamboo strips into coiled ribbon. In this preferred approach the tape is first force dried (such as in the method described in FIG. 1C) to a low moisture content. For current applications an appropriate moisture content has been found to be as low as ½ to 1 percent, although one skilled in the art will readily appreciate how to adjust the moisture level to optimize the ribbon properties. Plural tapes may be randomly laid next to each other, as described before, on an in-feed table 132. For example, if the ribbon is for use in a 2″×6″ lumber, 6 or 7 strips are typically placed side by side to form the desired width of ribbon. The strips are firmly gripped and fed into an extruder/hopper/die assembly 135-137 by one or more pair of opposing rollers 134 (preferably rubber). The encapsulation die 137 coats the tapes on top and bottom with plastic, preferably a moderately high temperature (e.g., around 400° F.) HDPE plastic. As the coated tape exits the die 137 it passes through two opposing chilled steel rollers 138 that squeeze the coated strips with sufficient pressure that the plastic is forced into the micro-porous surface of the bamboo tape. This provides a greatly improved mechanical lock on the surface of the tape. If stronger adhesion is desired, the tape can also be pre-coated with a binder agent such as described below. By using a sufficiently strong force between the rollers 138, the plastic lamination on the strips becomes thin, as few as several mils in thickness if desired. If desired, a micro-foaming agent as described below or a binder can also be mixed with the plastic before lamination. This compressed coating is thin enough to allow the bamboo to be readily coiled onto a spool, while also providing enough adhesion between adjacent strips that the ribbon can be coiled and uncoiled without the need for cross-stitching to hold the ribbon together during the coiling and uncoiling/feed processes. Alternatively, stitching can be used as described above, preferably before laminating the strips. The ribbon is then trimmed (e.g., a pair of cutting blades 139 can be set to leave a ribbon of 5 inches width for use in a 2″×6″ board), and passes through a cooling tunnel 140 to harden the plastic sufficient for the ribbons to be stored. A single coiler 145 can be used to receive and wind the coated plastic, while for multiple lines a coil system 150 with several coilers can be used. A traveling saw (not shown) may also be used to cut a ribbon being coiled when the spool of ribbon is sufficiently full.

An advantage of the embodiment described above in connection with FIG. 1D is that laminating the ribbons allows one to seal in a desired moisture level for the bamboo ribbon. Thus, one can prepare the ribbon spools in one continent, and seal the bamboo in a stable form that should remain substantially unchanged despite protracted transportation such as ocean shipping to another continent. The ribbon spools remain ready to use right out of the container when they arrive at the destination pultrusion site, and can make final production as easy to set up as unpacking the ribbon, hanging the spool on a coil dispenser unit (not shown) and feeding the ribbon into the finger dies 315 or even in-feed 325 of the pultrusion assembly 200.

While ribbon spools have certain advantages for storage, transportation, and dispensing of the bamboo in an automated process, this is not the only way in which appropriately dimensioned strips can be stored and moved. Individual strips can be stored in their full length, or partial length segments, in a flat manner and bundled together for ease of shipping. The bamboo can also be shipped in spools of ribbon one strip in thickness. In this case, any stitching can be done as a first step at the site of the pultrusion manufacturing. Alternatively, for some applications it may be acceptable to use fed horizontal strips, not ribbon spools. In this latter case, individual strips are randomly fed into the in-feed box 340, with the in-feed box 340 having an increased number of narrower input slits to accommodate the necessary number of individual strips (as opposed to multi-strip, and much wider, ribbons). While such an approach may not be as efficient as the use of bamboo ribbons, if the strips are of sufficient length the random laying of the strips still permits the use of a pultrusion, as opposed to a push, process and yields a strong core.

Turning now to FIGS. 1E through 1G, an alternative (and presently preferred) embodiment for producing bamboo tapes is illustrated. In this alternative embodiment, we use readily available bamboo tapes to feed the line, such as the roughly eight-foot (¾ inch wide by 1/16 inch thick) bamboo tapes commonly available by virtue of its use for other applications, like the weaving industry for commercial basket containers.

The line begins at a long (e.g., 16 foot) table 151 that includes a low-friction surface (i.e., slippery, such as an HDPE (high-density polyethylene) or Teflon surface). There are plural partitions 154 (e.g., with ¾″ high ridges), allowing for plural (e.g., 6 or 7 as illustrated) tapes 152 to be placed on the top surface of the table 151. Also on this table 151 are two opposing sets of resilient grip (e.g., rubber) idler feed rollers 155, positioned one on top of the other, preferably barely touching. There is a pair of rollers 155 at the discharge end of the table, and a second pair 153 of rollers one foot in from the end set. These rollers are non-driven and are on bearings. As the tapes 152 are fed into these roller sets the tapes are preferably “staggered” as to entry, so the joints of the tapes will not be adjacent/across from each other in the finished ribbons and cores.

Next, a slitter assembly 156 is positioned at or proximate the end of this table 151, and are powered by a gear-reduction motor (not shown) that allows the slitter rolls 157 to revolve at the desired line speed. These powered slitter rolls 157 slice the bamboo tapes 152, which enter e.g. as 6 or 7, into many more (e.g., approximately ±40 as illustrated) filaments 159 (e.g., each filament measuring ⅛″ wide by 1/16″ thick as illustrated). The slitter rolls 157 pull the bamboo tapes 152 from the table 151 by pulling them through the previously mentioned rollers 153, 155 (which can remain un-powered and idle), and as these tapes move down the line, new tapes are constantly placed on the table 151 immediately following a current tape being pulled through the assembly, thus allowing for production of a substantially continuous ribbon.

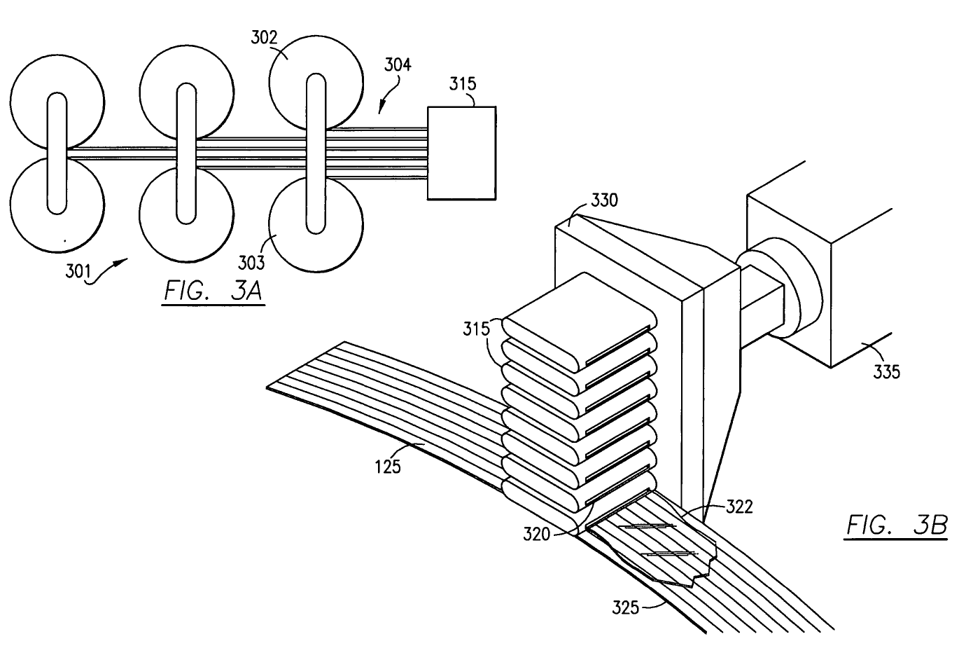

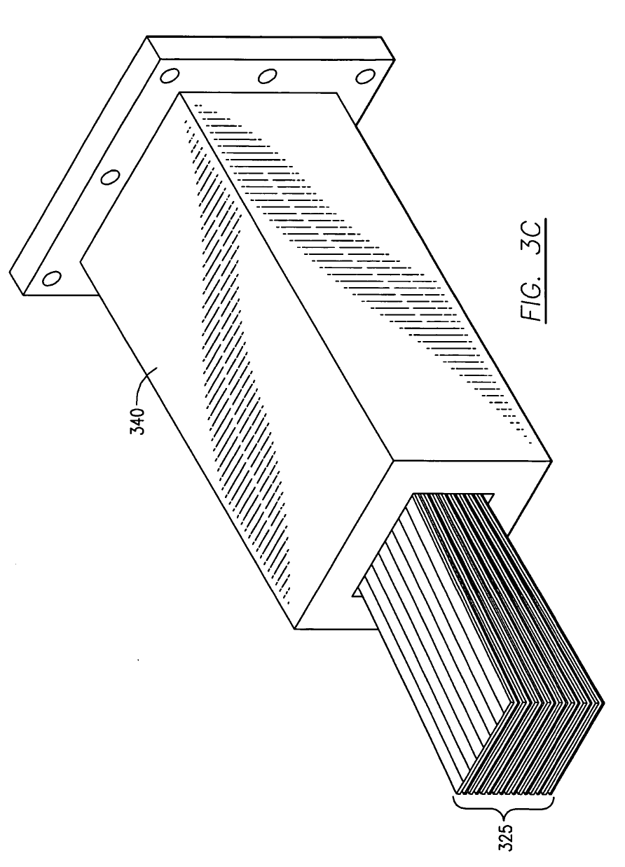

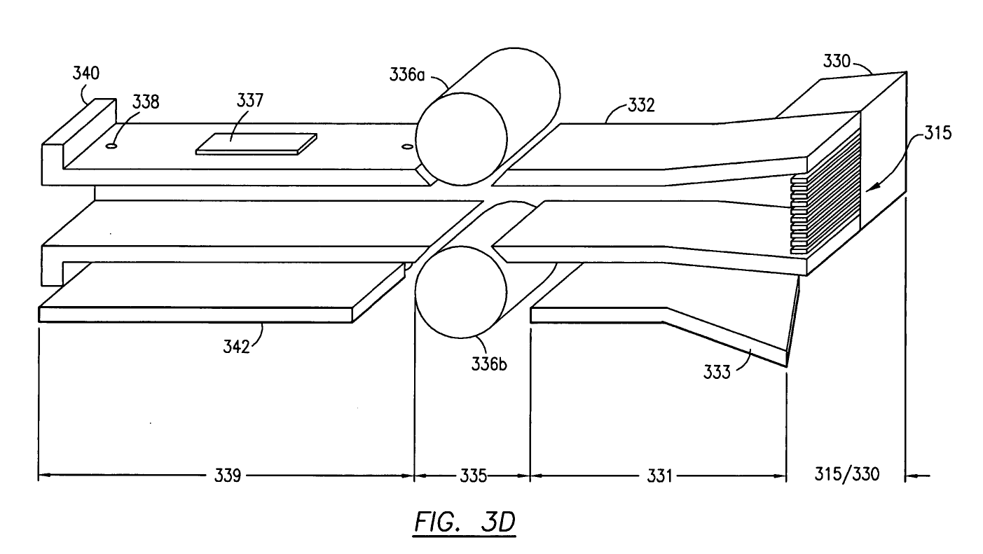

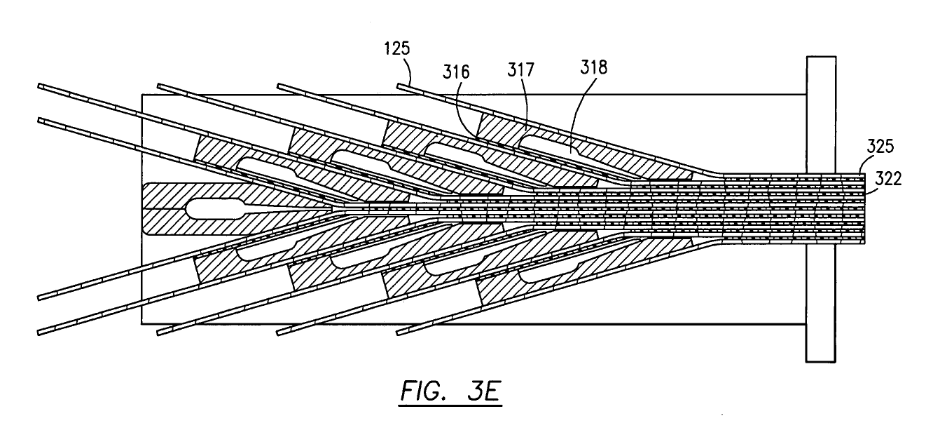

After the filaments are sliced by the slitter rolls, they travel into an alignment tunnel that forces the filaments more closely together, and then into a coating die 160 fed by an extruder (not shown). This coating die is preferably a pair of matched dies that spread a ribbon of molten plastic on both the upper and lower surfaces of the filaments as they pass through; one possible form of the matched dies could be two adjacent finger dies 315 such as are illustrated in FIG. 3B below. The resulting product exiting this die is a sandwich of molten plastic, bamboo filaments, and molten plastic (e.g., approximately 5″ wide in the illustrated case).

The resulting sandwich next enters a set of chill rolls 162 close to (e.g., within an inch of) the end of the die exit. The chill rolls 162, which are here under variable pressure from air cylinders (not shown), force/compress the two plastic layers together with sufficient pressure that they are forced into the micro-porous surface of the bamboo filaments. The chill rolls 162 also place sufficient pressure to force the plastic to encapsulate each of the filaments, thus forming a ribbon 163 of plastic encapsulated filaments. In this process, the new ribbon 163 is squeezed flat and becomes wider than the previous 5 inch width.

81 The newly formed ribbon 163 then passes through a cooling tunnel 164 (3 foot in length here, but length may vary based on factors like speed of the line, temperature, etc.). This cooling tunnel 164 is fed a cooling stream, e.g., cold air from an air-conditioning unit 165. The cooled ribbon then passes through two knife blades 166 that are set at a desired width for the final ribbon (e.g., 5 inches separation between them).

The excess is discarded and the new ribbon 168 travels to a set of powered and knurled “Pull Rollers” 167. These pull rollers 167 preferably set the line speed and the other powered rollers (chill 162 and slitter 157) and die 160 are set to match this output rate. The illustrated line can readily operate within a range from zero to eighteen feet per minute or more.

The ribbon 168 next travels (e.g., another 7 feet) to a powered reel coiler 169. This machine efficiently rolls the ribbon up on a plywood core (e.g., as illustrated the core can hold up to 500 lineal feet of ribbon). These cores could be made a very large diameter to hold enough ribbon to operate a lumber line for an entire days production cycle (as with all the dimensions presented here, this too is a matter of design choice that a skilled artisan will appreciate how to vary as necessary). The resulting bamboo “plywood” cores are designed to slide off the powered coiler, be transported to the factory, and be easily placed upon a “Payoff Rack” that, in the case of the 2″×6″ ribbon, can use 8 coils or more at one time, allowing resulting composite products to have 8 layers of 5 inch wide filament ribbons.

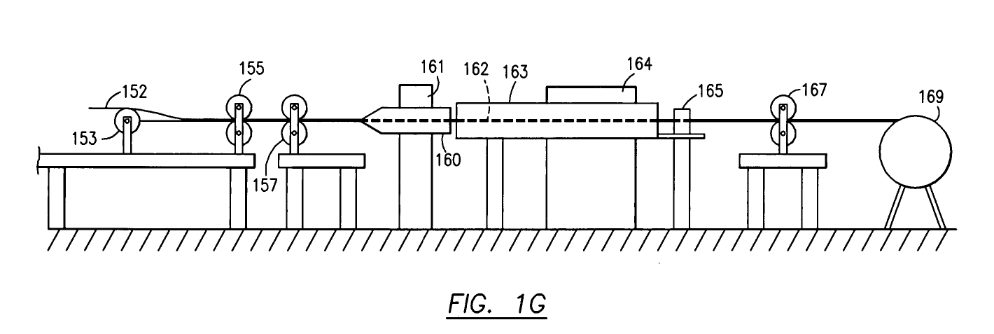

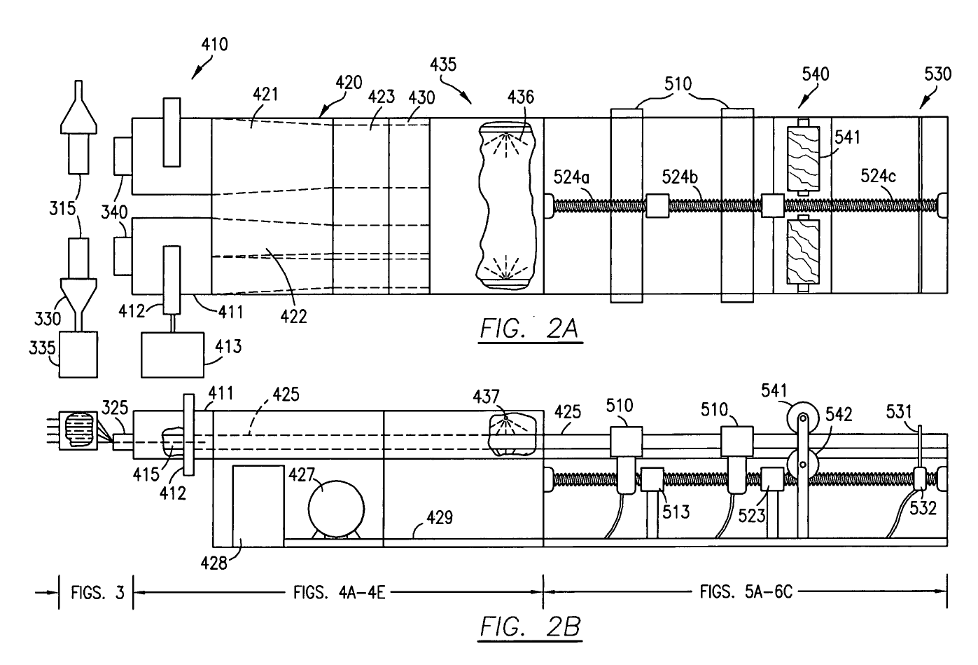

When the ribbon produced by the above process is applied to the assembly described in FIGS. 2A and 2B, a core can be produced that is superior in some applications than cores made of ribbons with wider bamboo strips. Thus, when fed into the composite manufacturing assembly (see, e.g., FIG. 3C, showing feed of the ribbons into the assembly infeed unit), a resultant core is formed that advantageously has better plastic bonding to the bamboo core members (i.e., aided by the infilling of the micro-porous surface layer of the bamboo during ribbon manufacture, which provides an improved, stronger plastic-bamboo bond after forming the core in the pultrusion assembly). The narrower strips, formed in a staggered arrangement, also provide an improved core capable of handling greater stresses and strains when used in load-bearing product. This alternative core may be used in a wide range of products, including those shown in connection with FIGS. 7A-7C below.

Turning now to FIGS. 2A and 2B, a first embodiment of an integrated pultrusion die assembly 200 is illustrated, with further reference being made to the subassemblies of FIGS. 3A-6B. Preceding this assembly 200 is a drying unit 120, as illustrated in FIG. 1C. In the case of a 2″ by 6″ dimensional lumber product as many as 8 layers of ribbons or more, (e.g., 50 to 65 individual tapes), may be needed as full-length reinforcement within the plastic matrix. In this case, the dryer is situated to receive 8 ribbons from spools hung before the input of the dryer, and the ribbons travel directly from the exit of the dryer to a set of 8 finger dies 315. As seen in FIG. 3B, these finger dies 315 are preferably stacked on one manifold 330, and are fed plastic by a first extruder 335. This method places a molten layer of plastic 322, of any chosen thickness depending on the pressure, speed and slot 320 width, between the layers of bamboo multi-tape ribbons 125. Thus, coming out of the finger dies 320 is an alternating bamboo fiber/molten plastic “sandwich” 325, which then travels into the in-feed box 340. For a typical bamboo tape of 1/16 inch thickness, the plastic ribbon may be approximately ⅛ inch in thickness, although both dimensions may be varied depending on the final application and characteristics needed. The plastic on the ribbon should preferably be kept to a minimum thickness, so the re-melt and bond can take place in the encapsulation die even at the greater throughput speeds that can be achieved using the disclosed pultrusion process.

In a first approach, no special prep or binding agent is needed before placing the molten plastic layers 322 between the bamboo ribbons 125. In some applications nothing more than the application of the molten plastic is needed to achieve sufficient levels of adhesion. However, in one presently preferred approach, a better adhesion is achieved using a microcellular foaming agent. The plastic can be any plastic, including HDPE (High Density Polyethylene) plastic, and is combined with this foaming agent. The foaming agent has been found to work well in the ½ to 1% range by weight, but is not limited to that range. HDPE is a little bit more temperature stable, a little stiffer, and is readily available since more recycled material is HDPE than any other type of plastic. However, any plastic resin matrix could do. What one looks for is characteristics allowing for adhesion to the tape to make a solid core, with preference typically being given to an optimum (higher) melt flow index. Presently preferred plastics include the olefin family. For different plastics, different pressures or temperatures may be used in the coater box, as someone skilled in the art would understand how to determine given the plastic.

The foaming agent presently preferred is a microcellular foaming agent, such as Hydrocerol made by Clariant Ltd., which agent presently provides smaller bubbles than other types foaming agents. The foaming agent provides additional adhesion because of the microcellular structure itself. In other words, instead of just providing a smooth plastic interface, the microcellular foaming agent makes little tiny bubbles that form an irregular interface that provides more “grab” between the plastic and the non-plastic (bamboo) surfaces. In addition to providing a greater adhesion, these agents also reduce the weight of the final product by as much as 50% or more, because the plastic is being changed from a solid mass into one interspersed with thousands of micro-bubbles, so less total mass of plastic is needed to produce the same dimensional product. Since this does not lessen the strength of the end product, provided by the bamboo core, this foaming agent can advantageously reduce weight and cost by reducing the plastic needed.

The foaming agent can be mixed in with the plastic prior to feeding into the finger dies 315. Alternatively, one can coat the bamboo tape with the agent between the drier and the finger dies 315, for example by a fine misting of the bamboo surface.

In addition to the use of a foaming agent, one can use a binder to provide better adhesion between the bamboo and the plastic. This would preferably be added via a misting unit, as adding it directly to the plastic would require too much binder per unit of plastic to achieve the same surface effect. Preferred binders include at least one member selected from the group consisting of maleated polypropylene, maleated polyethylene, maleic anhydride, hydroxyl methacrylate, N-vinyl pyridine, N-vinyl caprolactam, N-vinyl carbaxole, methacrylic acid, ethyl methacrylate, isobutyl methacrylate, sodium styrene sulfonate, bis-vinyl phosphate, divinyl ether-ethylene glycol, vinyl acetate, vinyl toluene, vinylidene chloride, chloroprene, isoprene, dimethylaminoethyl methacrylate, isocetylvinyl ether, acrylonitrile, glycidyl methoacrylate, N-vinyl pyrrolidone, acrylic acid, ethyl acrylate, itaconic acid, methyl acrylate, sodium vinyl sulfonate, cetyl vinyl ether, divinyl ether-butanediol, and octadecyl vinyl acetate.

The in-feed box 340 (see FIG. 3C) receives the layered or sandwiched bamboo-plastic ribbons 325, and aligns the multiple tape and plastic layers 325, from top to bottom and from side to side. The in-feed box allows any type of resin, including inexpensive recycled plastic, to be used within the center of the plastic lumber allowing a cosmetic cap-stock skin to be molded around the exterior for a wear factor and for aesthetic purposes. This outer skin is applied later in the operation, as discussed below. The in-feed box also provides a “wet seal” preventing molten plastic from the cap-stock operation from traveling in reverse and leaking from the encapsulation die 410, which is next in line.

Turning to FIGS. 3D-3F, an alternative, presently preferred embodiment of infeed and the finger die assemblies is illustrated. In this presently preferred embodiment, this improved assembly incorporates four zones or boxes (see FIG. 3D). The bamboo ribbon, upon leaving the reel assembly 301 (see FIG. 3A), having reels 302, 303 and guide 304 to feed bamboo ribbons to finger die 315, goes directly into the finger die assembly (shown in more detail in FIG. 3F). Plural bamboo ribbon layers (8, 10 or more, as desired) are coated with molten plastic at the same time in finger die 315. These finger dies are preferably contained within a box 320, which advantageously retains the heat and better controls the manufacture of the core. The bamboo ribbons 125 and molten plastic 318 form composite core 325, which then travels down a short (one foot) box 331, with viewing door 333. From there, the core 325 travels into a roller box 335, having a set of powered rollers 336a and 336b. These rollers advantageously minimize any entrapped air and steam bubbles in the plastic. Exiting the powered rollers the package travels down a heated box 339, having a viewing door 342. The heating allows the softening pre-melt on the top of the top ribbon and the bottom of the bottom ribbon (these are the only two surfaces where there is preferably no molten plastic layer deposited). The core 325 then enters the inlet 340 of the Guill encapsulation die where the complete outer layer is applied.

In one embodiment, designed for a 10 layer composite core, the finger dies are symmetrical with 4 dies on the top and 4 dies on the bottom, in rows (see FIG. 3F). Each of these dies has an upper half 317 (including cavity 318 for receiving and dispensing the molten plastic 322), and a lower plate 316. At the far inlet end there is a further “center” die that feeds the plastic between the 5 upper layers of ribbons and the bottom 5 layers (i.e., between ribbons 5 and 6). The top and bottom rows are at angle (15° in the illustrated case) to the center line. There is a short land after the plastic outlet on all except the center die. All 8, in the 2 rows, are able to be metered individually for flow rate. The center die should not be shut off, for safety reasons. This die design relies on bamboo ribbon of a consistent width and thickness.

Next, there is a lead-in box (in one embodiment, 12″ long), allowing the core 325 to stabilize prior to entering the squeeze rollers 327. It has a tapered wall 320; in the illustrated case, it narrows from 4¼″ to 1¾″ in height, being substantially constant before the rollers 336. This box 320 preferably has a hinged access door 333 to allow viewing of the package.

Next is the roller box. This box has two knurled rolls 336a and 336b, preferably power driven at a variable rate from zero to the desired speed (as illustrated, 32 feet-per-minute, by a 3 hp motor and transmission). The bottom roll 336b may be fixed in position and the top roll 336a movable up or down (as illustrated, with a 2″ travel). At the full down position the top and bottom rolls may touch. This system should have sufficient power to move either the coated, or (at start-up) uncoated ribbons 125, all the way through the pultrusion line to the pullers 510. The two rolls are preferably fully enclosed (at close tolerance), within its box 335, which bolts to box 320 on one end and to box 339 on the other.

Finally, a heating box 339 functions to heat the top of the top tape and the under surface of the bottom tape prior to feeding the core 325 to the encapsulation die 410. This box (as illustrated, 24″ long) should be heated, preferably with heaters 337 on the top and bottom, the desired temperature being a matter of design choice depending on the layers and configuration chosen. One may also take advantage of the “bell-mouth” opening at the inlet of the Guill die, with a vacuum port 338 on this box 339 directly above this opening. This box, similar to box 331, should have a hinged access door 342 to enable an operator to see the bamboo/plastic composite as it enters the Guill die, as well as to clean the system prior to start up.

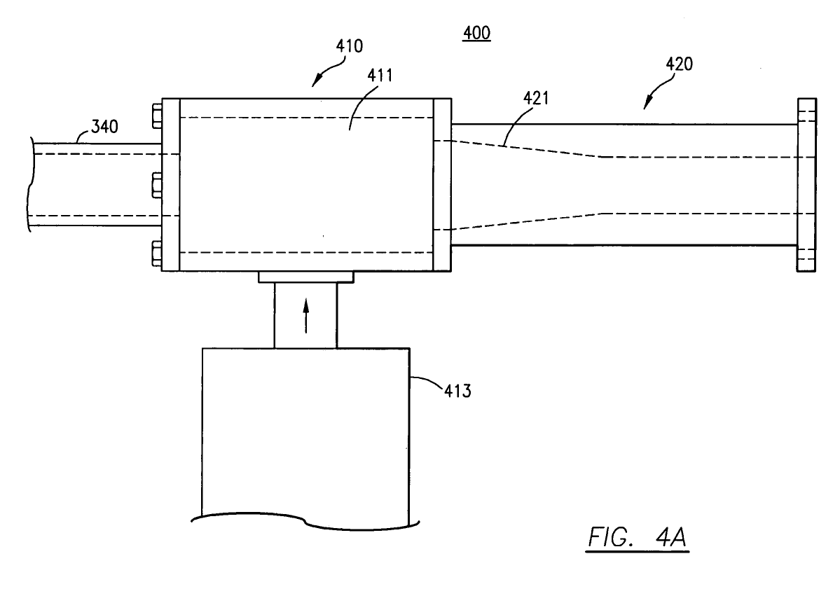

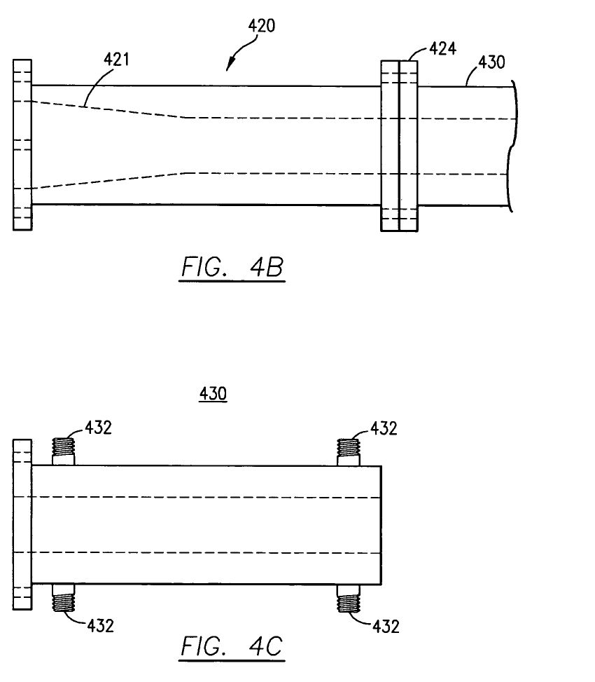

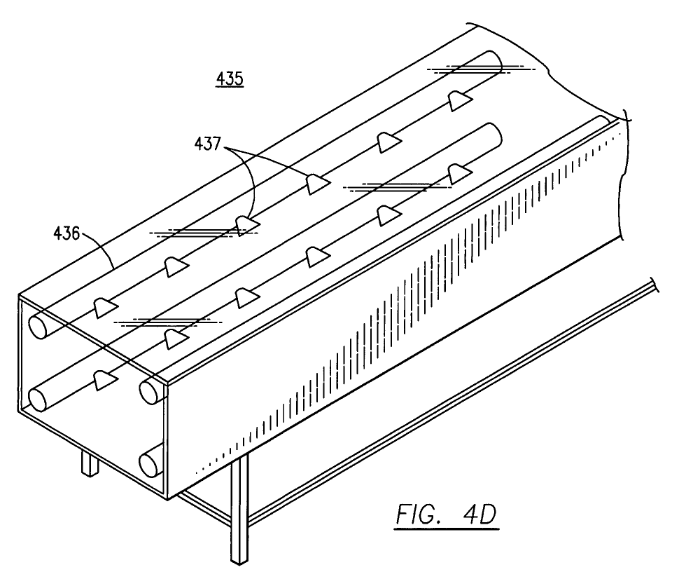

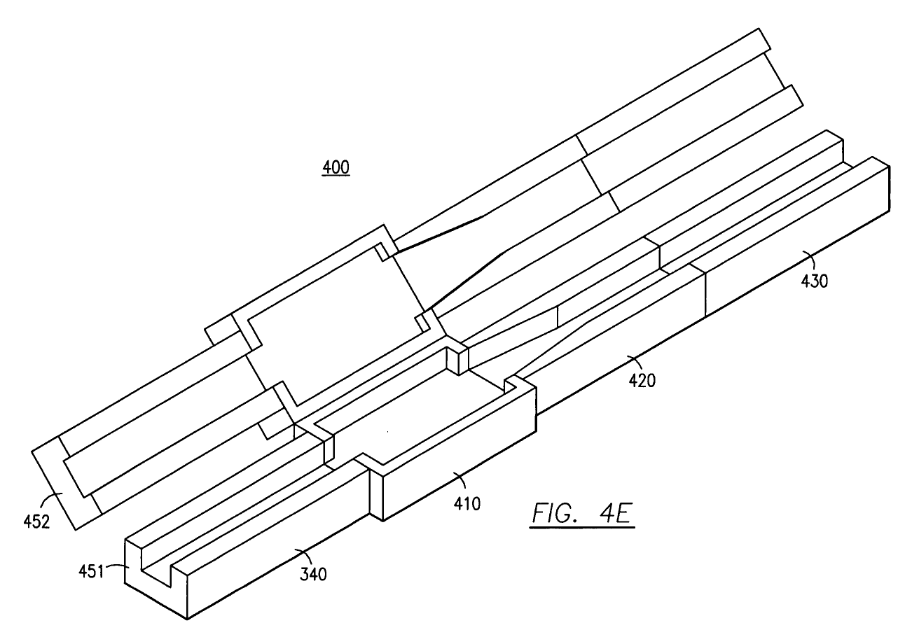

The multi-tape ribbons, with molten plastic between the layers, properly sized and aligned by the in-feed box 340 then travels into the encapsulation die 410 (FIG. 4A). This die 410 is fed additional molten plastic by a second extruder 413. Utilizing two extruders 335, 413 allows an operator to individually adjust the volume and temperature of each plastic and to “fine-tune” the flow to each die 315, 410. Also, two extruders allow two very different types of plastic resins to be molded simultaneously, should that be desirable. The cavity 411 within the encapsulation die 410 is preferably dimensionally larger then the in-feed box 340, allowing the molten plastic cap-stock layer to flow around the outside of the core layer, formed by the chamber of the in-feed box 340. A pressure transducer may be advantageously used to insure that there is enough plastic to encapsulate the core, but not so much that the plastic is forced back into the finger die and out through the slots.

The moldable product 425 (a core of bamboo-plastic surrounded by a further plastic material) is then passed through a forming (or calibration) die 420 (FIGS. 4A, 4B). The forming die 420 includes tapered portion(s) 421, 422, and straight portion(s) 423. The tapered portion typically has about 1 degree per foot of taper, which helps squeeze the plastic to remove entrapped air and consolidate the plastic and make it bind to the ribbons better. This forming die 420 allows the product 425 to be formed into the desirable outer dimension (as found in the straight portion 423) for the remainder of the formation process. While there is no presently preferred out dimension, some applications may find it advantageous to have a thick layer of surrounding plastic and only need a small core, and a layer of 3/16 inch is generally preferred as a minimum thickness to provide a durable “wear” layer.

The new product then passes into a chilling die 430 (FIGS. 4C). This die 430 is cooled from within by a coolant such as chilled water, which can be cooled to as low as 34 degrees Fahrenheit if necessary. The cooling water is preferably supplied via inlets 432, and circulates around the straight piece through which the product 425 travels. This chilling die 430 helps to solidify the product. Since the forming die 420 and chilling die 430 abut each other, an insulating block is placed between these sections 423, 430.

From the chilling die 430 the product 425 passes through the cooling tank 435 (FIGS. 4D). Tank 435 includes pipes 433 (in this example two on top and two on bottom along opposite corners of the tank) each having plural spray jets 434. This tank 430 is of sufficient length to extract enough remaining heat from within the product to allow it to be pulled by clamps without cosmetically damaging the outer surface of the new board or other product.

The cooling tank 435 may advantageously include a plexiglass lid through which the product 425 can be viewed. Moreover, each of the dies 340, 410, 420 and 430 may advantageously be made to include a flip-open upper or lid portion 452 and a lower portion 451 (FIG. 4E). This flip-open feature is particularly useful at start-up, when placing initial bamboo ribbons or cores through the assemblies 400 so the leading portion of bamboo ribbon may be used to start pulling product through the assembly. This flip feature also assists in cleaning the dies at shut-down.

Another advantage of the approach described here is that the die assembly 400 can be made in a modular way. Thus, a series of different dies (e.g., 2″×6″ and 2″×4″ forming dies) could be used on the line on a first day, and part of the dies swapped out for a different size the next day. With appropriate alignment mechanisms, which a skilled artisan would readily understand how to implement, the dies and tape could be aligned such that the clamps handle five or more different sizes of plastic lumber through five or more different dies.

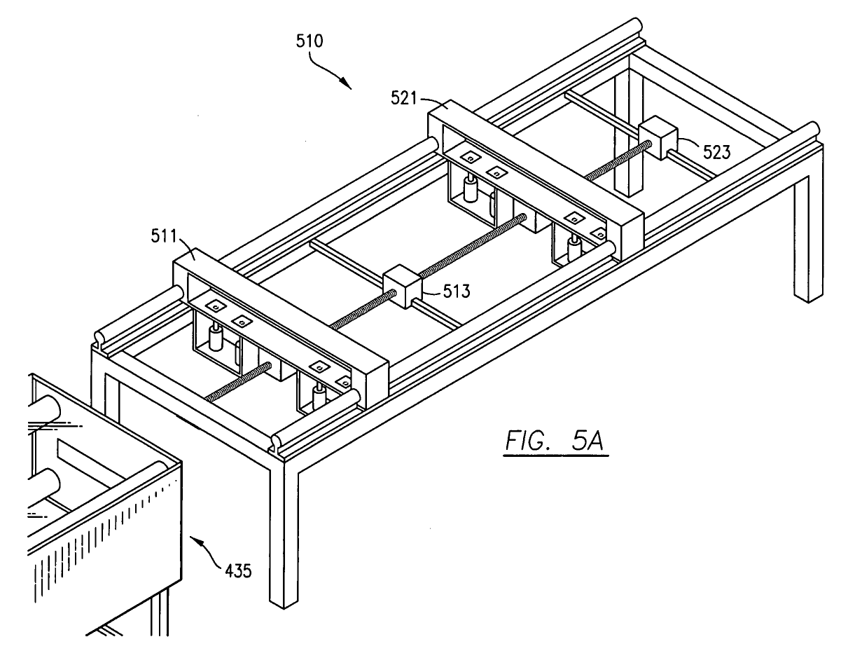

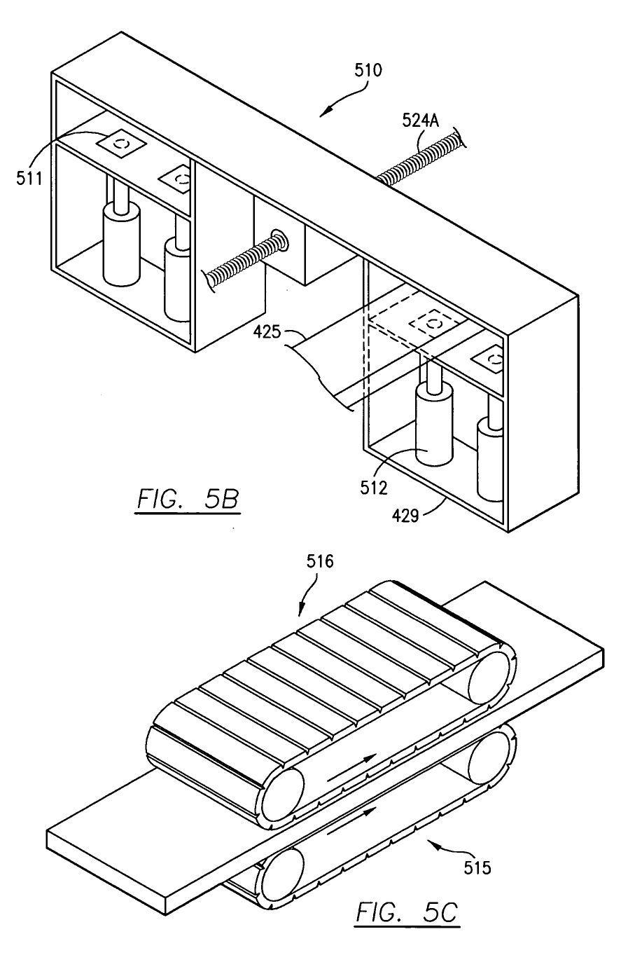

When the product 425 exits the cooler tank 435 it travels next into the first clamp 512 of the “pultrusion” assembly 510 (FIG. 5A-5C). This machine includes two or more traveling clamp units 511, 521 that are arranged in tandem and a significant distance away from one another. These clamp units 511, 521 travel back and forth and are controlled via drives 513, 523 by a central processor or computer system (not shown) that controls clamp 511 to hand the product 425 over to clamp 521 in such a way that the travel of the product is non-stop and with a substantially constant velocity (the speed for a particular run is determined by the operator). This pultrusion process allows for a faster rate of production than typical “push” (extrusion) processes, since the clamps 511, 521 are pulling the molded product 425, which pulls the embedded bamboo tape 325 further back in the assembly as it is enters and passes through the die assemblies 400.

The traveling clamp units 511, 521, further illustrated in FIG. 5B, are preferably full width (thus moving multiple board types 425 at the same time) and pressure sensitive, which means they will sense the thickness of the boards 425 being made. While such clamps are more expensive, they do allow an operator to run different dimensional pieces through at the same time. For example, one could make a 2″×6″ inch composite on a first path, a 2″×10″ inch composite on a second, and a 4″×4″ inch plastic lumber on a third path. The clamp would move into position and feel the 4″×4″ board without indenting it, while the clamp next to it might move further when clamping on the 2″×6″ piece, determining how much to clamp not based on a preset thickness but by a pressure measurement from the pressure sensitive clamps 512, 522. The individual clamps 511, as illustrated, could be operated e.g. by a hydraulic cylinder 512 to move upwards into position, forcing a member 425 against a fixed or retractable upper member (not shown), but any vertical or horizontal orientation can work with rectangular members, and other orientations can be used for ellipsoidal or irregularly shaped members 425. These clamps are further arranged such that one of the clamps 511 is clamped on the product and pulling (as the clamp is moved by screw 524a) while the other clamp 521 can release and re-position itself (via screw 524b) back at a starting position to ready itself to take over the pulling from the first clamp.

Alternatively, in lieu of the multiple clamps 511, 521, one may use other methods of pulling the hardening plastic members 425 such as the caterpillar puller 515, 516 illustrated in FIG. 5C. In a preferred approach, the caterpillar assembly would include two caterpillars or cleater pullers, each positioned opposite each other and together providing pressure against the plastic member 425 and a pull in the desired direction of travel. This can be accomplished by a variety of different means, including fixing the bottom unit position while varying the top unit so it provides the desired downward pressure against the product 425, or allowing both pullers 515, 516 to be moved (vertically or horizontally, depending on the positioning) so as to provide the desired pressure. This also allows the pultrusion assembly to dispense with the additional traveling mechanism for the clamps, since the caterpillar unit can be a fixed unit spanning one or more lines of product 425. One or both of the pullers are preferably provided with a variable drive motor, so a controller can be used to adjust the speed at which the member 425 is pulled through the dies for different assembly configurations/desired products 425. For example, a slower speed may be desired for a 4″×4″ or 2″×10″ board 425 than a 2″×4″ product 425, and the variable speed drive readily accommodates the different product runs.

One skilled in the art will appreciate from the above discussion that the type of puller used may vary, depending on typical assembly design factors and the type of product involved. For example, if all the production from a multi-line assembly was of the same dimensioned product 425, it would be possible to use just one caterpillar unit 515, 516 stretching across with width of the assembly. Further, rollers and other devices may be substituted for one or more of the caterpillar pullers, as long as they can be used to achieve sufficient pull on the product 425 while still on the assembly line without deforming the plastic in any undesirable manner.

One particular advantage of this pultrusion process over prior art techniques is the ability to pull the product 425 through the die assemblies 400. Prior art plastic lumbers rely on the pressure from the extruder/die assemblies to push the plastic down the assembly. This is required, since such prior art plastic lumbers do not have a reinforced core. Because the pultrusion process now supplies all the force needed to move the composite product through the assembly, the pressure requirements on the extruder are reduced since all the extruder has to do is supply plastic to the die, not move the product forward. A limiting factor in non-protrusion systems can be the pressure of the plastic developed by the extruder to push the plastic through a dye. The pultrusion system disclosed here does not have this same limitation, since the force of the clamps 512, 522 is transmitted via the bamboo ribbons in the core, and the plastic is pulled along via the core. Thus, it is now possible to make multiple boards (five or more) at once on one line, instead of the single board typical of prior art assemblies.

The product 425, which in the illustrated case is composite plastic dimensional lumber, next travels through two opposed embossing rolls 541, 542 (FIG. 5D) that are heated to a sufficient temperature to allow these rolls to imprint an artificial effect on the opposing top and bottom of the board surfaces. The embossed effect can be any desired pattern, including a “wood-grain” pattern, a school symbol, or other natural or artificial design. The product finally moves to an automatic “traveling” cut-off saw 531. This saw is programmable, also preferably controlled by the processor or computer via use of drive 532, allowing the operator to select a desired length for the lumber currently passing through the line. A pneumatic system may also be advantageously used, with a pump 428 and reservoir 427 connected to each of the drives 513, 523 and 532 for the traveling units. Once sawn, the new embossed lumber “board” 550 may be moved to inventory in preparation for shipment to the customer.

The master computer or controller (not shown), may be any convenient processor and memory. It can be programmed to handle all control situations at the same time, including controlling the temperature of the drying apparatus 120, the screw speed and temperatures of the two extruders 335, 413, the temperatures of the two manifolds 330, 412 that feed their respective dies, the temperature of the dies individually, the temperature of the spray tank 435, the speed of the traveling clamps 511, 521, or alternatively caterpillar units 515, 516, the speed and temperature of the embossing rolls 540, and finally, allowing for the proper coordination of the traveling saw 530. Also, the computer will accumulate quality and quantity data as the production line operates, to allow an operator to fine tune the parameters for future production runs.

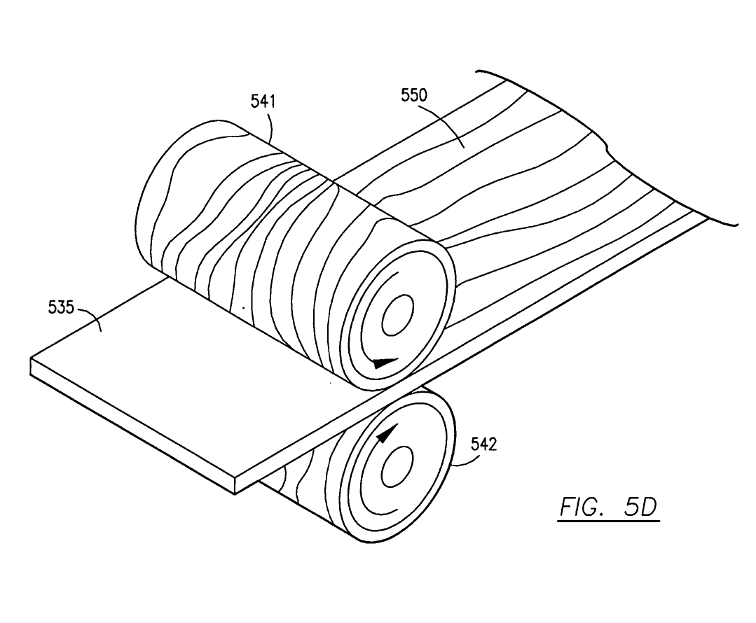

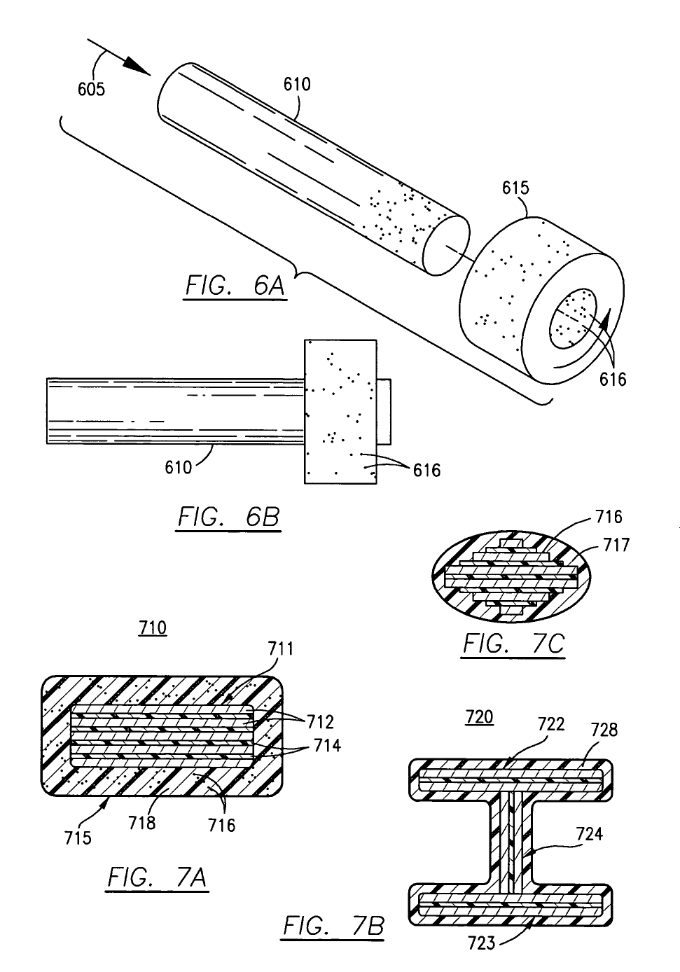

The computer can also control a novel method of creating a wood-grain coloring effect by which the multi-color materials are blended and “dotted” in such a way that it mimics the natural appearance of wood. The contrasting-color dots are “dragged” through the die in order to enhance the appearance, and applied by a revolving sleeve 610 (FIGS. 6A-6B). This sleeve is placed just before the aperture of the forming die 420. The revolving sleeve 610 includes a rotating sleeve 615 that preferably has randomly placed tiny holes 616. This allows the dots to appear in random order on the product 425 as it passes under the sleeve 615. Other colors can be added to the plastic as it flows into the encapsulation die 410 (e.g., by pellets added to the extruder), but such an approach requires more colorizing material and is used where a substantially uniform color is desired throughout the product. By adding colorizers with different melt temperatures, it is possible to achieve a certain “streaking” effect in the plastic as they melt, which mimics wood grain. The color roller assembly is used for surface appearances, particularly to apply a more random appearance, allowing one to create a more “natural” look to the product 425.

In an alternative embodiment, the pultrusion assembly can be used to make complete or partial cores, but stop short of making a final product. In this core pultrusion assembly, the embossing 540 and color roller 610 are not used, and the encapsulating die 410 may optionally be omitted. The bamboo ribbon and plastic layered sandwich core is still formed and cut to size, but without the full volume and weight of the end product. This process may be advantageously used, for example, if it proves more economical to produce a core near the bamboo growth and transport the core, than to just make bamboo strips or ribbons. As such, the core is sufficiently encapsulated to avoid concerns like varying humidity conditions in transport (i.e., either for further drying, or for absorption of unwanted salt water spray). Once the core arrives at the destination, the core is run through an additional encapsulation/forming/chilling die assembly for extrusion shaping, or placed in preformed molds, and formed into the desired plastic-encapsulated reinforced-core shape by known extrusion or mold processes.

Two illustrative views of examples of the end products of the pultrusion assembly 200 are shown in FIGS. 7A through 7C. FIG. 7A shows a cross-sectional view of a plastic lumber member 710 with a reinforced core 711. The reinforced core is made of alternating layers of bamboo ribbon 712 and a plastic layer 714. The core 711 is surrounded by an encapsulating layer of plastic 715. While this can be a solid layer of plastic, one may advantageously use a bubble-creation agent like the microcellular foaming agent referred to above to create numerous tiny bubbles 716 in the plastic 718. This permits savings in both the quantity of plastic used and in the final weight of the plastic lumber, without compromising the strength which is substantially provided by the core. FIG. 7B is similar to the plastic lumber of FIG. 7A, except the core 716 and outer layer of plastic 717 are in a substantially circular shape. One skilled in the art will appreciate how any substantially ellipsoidal form (e.g., by layering the bamboo strips 712 of different widths such that they generally form an ellipsoidal shape), or other form of substantially uniform cross-section, can now be made with the disclosed process.

FIG. 7C is a cross-sectional view of an I-beam made with a reinforced bamboo core. In the illustrated case, multilayered cores 722, 723 and 724 are used for the opposing flanges and central section of the I-beam, each of the cores being similarly composed of alternating layers of bamboo ribbon and plastic. Surrounding each core is a plastic layer 728 added by the encapsulation die 410. In this case, one or more of the finger dies 315 can be placed in a vertical orientation so as to form the appropriate vertical cross member. Alternatively, the core can be formed by other means such as a criss-cross pattern by other layering or specialty molds, with this member being allowed to harden before being introduced to the in-feed box 340. One can also use a carrier strip, bound to the center portion of the I-beam, to assist with the introduction and travel of the center member through the assembly 200.

A skilled artisan will readily appreciate that a wide variety of shaped, reinforced products can now be made, including but not limited to, dimensional structural lumber and beams, railroad ties, utility poles, and marine pilings. The addition of the linear bamboo reinforcement (typically running the full-length of the product) provides a breaking strength up to four times or more than that of softwood lumber. The low cost bamboo fibers allow the resulting products to be sold for less than comparable solid or wood-filled plastics.

Of course, one skilled in the art will appreciate how a variety of alternatives are possible for the individual elements, and their arrangement, described above, while still falling within the spirit of my invention. Thus, for example, other cellulosic material can be used in lieu of bamboo, such as kenaf, jute, and sisal, and other forms than ribbon or tape can be used. However, a bamboo tape is presently preferred in view of bamboo's relative abundance, ease of growth, and low cost but high strength when compared to other cellulosic materials, and a tape can be advantageous in terms of ease of transport and manipulation. The tensile strength of bamboo may prove a significant advantage for most applications since bamboo has a tensile strength around 55,000 psi (pounds per square inch). This is greater than even low alloy steels (around 45,000 psi), and much greater than soft woods like southern yellow pine (in the 12,000 to 14,000 range).

While the above describes several embodiments of the invention used primarily in connection with the production of a bamboo-reinforced core composite, those skilled in the art will appreciate that there are a number of alternatives, based on system design choices and choice of core and encapsulation materials, that still fall within the spirit of my invention. For example, while the invention has been primarily described in connection with bamboo strips or tape, as noted above it is applicable to other non-wood, cellulosic stalk plants. Further, while a first embodiment describes an integrated pultrusion assembly for making the reinforced core product, the pultrusion process may by used to make only a portion of the final product (the core), while other extrusion or molding processes may be advantageously used in forming a final product around the pultrusion-produced cores. Thus, it is to be understood that the invention is not limited to the embodiments described above, and that in light of the present disclosure, various other embodiments should be apparent to persons skilled in the art. Accordingly, it is intended that the invention not be limited to the specific illustrative embodiments but be interpreted within the full spirit and scope of the appended claims.

1. A pultrusion apparatus operable for making reinforced plastic load-bearing products, comprising:
a feed unit operable for receiving plural bamboo strips, coating said strips with a first plastic material, and forming a core member of adjacent bamboo strips;
an encapsulation die operable for forming an outer plastic layer on the core so as to form a composite bamboo-plastic member;
a pultrusion unit positioned to receive the composite following the encapsulation die and operable for pulling the composite from the pultrusion unit; and
a finishing unit operable for forming the composite into plural load-bearing products.

2. The apparatus of claim 1, further comprising plural feed units such that plural core members are simultaneously formed, the encapsulation die and pultrusion unit also being configured to simultaneously process plural composites.

3. The apparatus of claim 1, wherein the pultrusion unit comprises a drive unit operable for varying the rate at which the composite is formed.

4. The apparatus of claim 3, wherein the pultrusion unit comprises at least one of the group of a caterpillar unit and a pair of pressure sensitive clamps.

5. The apparatus of claim 1, wherein the encapsulation die further comprises a first die unit for feeding molten plastic into a position covering the core.

6. The apparatus of claim 5, wherein the first die unit comprises a mixer operable for mixing a microfoaming agent with said molten plastic

7. The apparatus of claim 5, wherein the encapsulation die further comprises a forming die with a predetermined shaping member.

8. The apparatus of claim 7, wherein the shaping member is one of the group of ellipsoidal, rectangular, and irregular polygonal cross-sectionally shaped member.

9. The apparatus of claim 7, wherein the encapsulation die further comprises a chilling die coupled to the forming die.

10. The apparatus of claim 7, wherein the encapsulation die further comprises a cooling tank coupled to the chilling die operable for cooling the outer plastic layer so that the pultrusion unit may operably pull the composite without substantially deforming the outer plastic layer.

11. The apparatus of claim 5, wherein the encapsulation die further comprises a colorizer unit operable for placing colorizer on the outer plastic layer while still fluid so as to achieve a predetermined color and pattern on a surface of the composite.

12. The apparatus of claim 1, wherein the finishing unit comprises a traveling saw operable for cutting the composite so as to form a reinforced plastic load-bearing product of predetermined dimensions.

13. The apparatus of claim 12, wherein said product is a dimensional lumber product having one of a standardized set of dimensions used in construction.

14. The apparatus of claim 12, the finishing unit further comprises embossing rollers.

15. The apparatus of claim 1, wherein the feed unit comprises a finger die operable for coating said plural bamboo strips with said first plastic between vertically adjacent strips.

16. The apparatus of claim 15, wherein the plural bamboo strips comprise one or more ribbons of bamboo, each ribbon comprising plural adjacent bamboo tapes joined together, the feed unit further comprising a dispenser operable for receiving one or more spools of said ribbon and unwinding said one or more spools to provide said ribbon to said finger die.

17. The apparatus of claim 15, wherein the feed unit further comprises a coater operable for coating said strips with a binder before coating said strips with the first plastic.

18. The apparatus of claim 17, wherein the binder is one of the group of maleated polypropylene, maleated polyethylene, maleic anyhdride, hydroxyl methacrylate, N-vinyl pyridine, N-vinyl caprolactam, N-vinyl carbaxole, methacrylic acid, ethyl methacrylate, isobutyl methacrylate, sodium styrene sulfonate, bis-vinyl phosphate, divinyl ether-ethylene glycol, vinyl acetate, vinyl toluene, vinylidene chloride, chloroprene, isoprene, dimethylaminoethyl methacrylate, isocetylvinyl ether, acrylonitrile, glycidyl methoacrylate, N-vinyl pyrrolidone, acrylic acid, ethyl acrylate, itaconic acid, methyl acrylate, sodium vinyl sulfonate, cetyl vinyl ether, divinyl ether-butanediol, and octadecyl vinyl acetate.

19. The apparatus of claim 15, wherein the first plastic comprises a mix of a selected plastic and micro-foaming agent, the feed unit further comprising a mixer operable for mixing the selected plastic and the micro-foaming agent.

20. The apparatus of claim 1, wherein the feed unit further comprises an in-feed unit attached to the encapsulation die operable for positioning the plural bamboo strips after being coated with the first plastic so as to form said core member.

21. A method for making reinforced plastic load-bearing products, comprising:
(a) receiving plural bamboo strips in a feed unit, coating said strips with a first plastic material, and forming a core member of adjacent bamboo strips;
(b) forming an outer plastic layer on the core in an encapsulation die so as to form a composite bamboo-plastic member;
(c) receiving the composite in a pultrusion unit and moving the composite so as to pull the composite through the encapsulation die; and
(d) forming the composite into plural load-bearing products in a finishing unit.

22. The method of claim 21, further comprising simultaneously forming plural core members plural using plural feed units, and simultaneously processing plural composites in the encapsulation die and pultrusion unit.

23. The method of claim 21, wherein varying the rate at which the composite is formed using a drive unit of the pultrusion unit.

24. The method of claim 23, wherein step (c) comprises moving the composite via at least one of the group of a caterpillar unit and a pair of pressure sensitive clamps.

25. The method of claim 21, wherein step (b) further comprises feeding molten plastic into a position covering the core.

26. The method of claim 25, wherein step (b) further comprises mixing a microfoaming agent with said molten plastic in said encapsulation die.

27. The method of claim 25, wherein step (b) further comprises shaping the composite using a forming die with a predetermined shaping member.

28. The method of claim 27, further comprising shaping the composite into one of the group of ellipsoidal, rectangular, and irregular polygonal cross-sectionally shaped product.

29. The method of claim 27, further comprising cooling the composite in a chilling die following a forming die.

30. The method of claim 29, further comprising cooling the composite in a cooling tank following the chilling die so that the pultrusion unit may operably pull the composite without substantially deforming the outer plastic layer.

31. The method of claim 25, wherein step (b) further comprises placing colorizer on the outer plastic layer while still fluid so as to achieve a predetermined color and pattern on a surface of the composite.

32. The method of claim 21, wherein step (d) comprises cutting the composite so as to form a reinforced plastic load-bearing product of predetermined dimensions.

33. The method of claim 32, further comprising cutting the composite so as to form a dimensional lumber product having one of a standardized set of dimensions used in construction.

34. The method of claim 32, wherein step (d) further comprises embossing the composite.

35. The method of claim 21, further comprising coating said plural bamboo strips with said first plastic between vertically adjacent strips using a finger die.

36. The method of claim 35, further comprising providing plural ribbons of bamboo to the finger die using a spool dispenser, wherein the plural bamboo strips comprise one or more ribbons of bamboo, each ribbon comprising plural adjacent bamboo tapes joined together.

37. The method of claim 35, further comprising coating said strips with a binder before coating said strips with the first plastic, wherein the binder is one of the group of maleated polypropylene, maleated polyethylene, maleic anyhdride, hydroxyl methacrylate, N-vinyl pyridine, N-vinyl caprolactam, N-vinyl carbaxole, methacrylic acid, ethyl methacrylate, isobutyl methacrylate, sodium styrene sulfonate, bis-vinyl phosphate, divinyl ether-ethylene glycol, vinyl acetate, vinyl toluene, vinylidene chloride, chloroprene, isoprene, dimethylaminoethyl methacrylate, isocetylvinyl ether, acrylonitrile, glycidyl methoacrylate, N-vinyl pyrrolidone, acrylic acid, ethyl acrylate, itaconic acid, methyl acrylate, sodium vinyl sulfonate, cetyl vinyl ether, divinyl ether-butanediol, and octadecyl vinyl acetate.

38. The method of claim 35, further comprising mixing a plastic base with a micro-foaming agent to form said first plastic.

39. The method of claim 21, further comprising positioning the plural bamboo strips after being coated with the first plastic using an in-feed unit so as to form said core member.

40. A pultruded composite load-bearing product comprising a composite bamboo strip and plastic core surrounded by an outer plastic layer adjoining the core.

41. The product of claim 40, wherein the core comprises alternating layers of bamboo ribbon and plastic, each ribbon comprising plural adjoined bamboo tapes.

42. The product of claim 41, wherein the core has a substantially uniform longitudinal cross-section.

43. The product of claim 42, wherein said cross-section is substantially rectangular.

44. The product of claim 42, wherein said cross-section is substantially ellipsoidal.

45. The product of claim 42, wherein said cross-section has a substantially irregular shape.

46. The product of claim 45, wherein said irregular shape is an i-beam shape.

47. The product of claim 40, wherein a plastic layer of said core comprises microcellular structure formed by a microfoaming agent.

48. The product of claim 40, wherein the outer plastic layer comprises microcellular structure formed by a microfoaming agent.

49. The product of claim 40, wherein said outer plastic layer consists of a narrow wear layer surrounding the core.

50. The product of claim 49, wherein the wear layer is narrower than about ¼ inch in thickness.

51. A reinforced composite comprising a core comprising a bamboo ribbon bonded to a plastic matrix, and an outer plastic layer melded to an outer surface of the plastic matrix of the core.

52. The product of claim 51, wherein at least one of the plastic matrix and outer plastic layer comprise a microcellular structure formed by a microfoaming agent.

53. A bamboo-reinforced composite comprising:
a core comprising plural bamboo strips bonded to a microfoamed plastic formed by a microcellular foaming agent; and
an outer plastic layer adjoining the microfoamed plastic.

54. The product of claim 53, wherein the plural bamboo strips comprise plural bamboo ribbons, each ribbon comprising plural adjoined bamboo tapes.

55. The product of claim 54, wherein the core is substantially rectangular,

56. The product of claim 53, wherein the composite is a pultruded composite such that the core and outer plastic layer each have a substantially uniform longitudinal cross-section.

57. The product of claim 56, wherein said cross-section of the pultruded composite is substantially rectangular.

58. The product of claim 56, wherein said cross-section of the pultruded composite is ellipsoidal.

59. The product of claim 56, wherein said pultruded composite comprises an i-beam.

60. The product of claim 53, wherein outer plastic layer consists of a narrow wear layer surrounding the core.

61. The product of claim 60, wherein the wear layer is narrower than about ¼ inch in thickness.

62. A system for making laminated bamboo strips comprising:
a dryer operable for drying a bamboo strip to a predetermined moisture level;
a die operable for coating the strip with a plastic to form a coated bamboo strip;
a compression unit operable for compressing the coated bamboo strip so as to form a bamboo-plastic laminate strip; and
a bundling unit for preparing the laminated strips for shipping.

63. The system of claim 62, wherein the compression unit is a pair of rollers configured to compress the bamboo-plastic laminate so as to force the plastic into the bamboo strip.

64. The system of claim 62, wherein the bundling unit comprises a spooler operable for receiving the laminated strip and rolling the laminated strip onto a spool.

65. The system of claim 62, wherein the bundling unit comprises a cutter and stacking unit operable for cutting the laminated strip into predetermined cut lengths and stacking cut laminated strips into bundles.

66. The system of claim 62, further comprising a trimming unit operable for trimming at least one side of the laminated strip

67. The system of claim 62, wherein the strips are bamboo ribbons, further comprising a sewing unit operable for stitching plural bamboo tapes into a bamboo ribbon

68. A method for making laminated bamboo ribbon comprising:
(a) drying a bamboo strip in a drying unit to a predetermined moisture level;
(b) coating the strip in a die with a plastic to form a coated bamboo strip;
(c) compressing the coated bamboo strip to force the plastic into the bamboo strip so as to form a bamboo-plastic laminate strip; and
(d) preparing the laminate strip for shipping using a bundling unit.

69. The method of claim 68, wherein step (a) comprises drying the strip to a moisture level between the range of approximately ½ and 1 percent.

70. The method of claim 68, wherein the strip is a bamboo ribbon, and step (c) further comprises compressing the coated bamboo ribbon using opposing rollers.

71. The method of claim 70, wherein step (d) comprises trimming at least one side of the laminate ribbon, and receiving the laminate ribbon and rolling the laminate ribbon onto a spool.

72. A pultrusion unit operable for making dimensional plastic load-bearing products, comprising:
plural feed units operable for receiving plural bamboo ribbons, coating said ribbons with a first plastic material, and forming plural core members each core member being formed of plural bamboo ribbons;
an encapsulation die operable for forming an outer plastic layer on each core so as to form on each a composite bamboo-plastic member;
a pultrusion unit comprising a drive unit, and further comprising at least one of the group of a caterpillar unit and a pair of pressure sensitive clamps, operable to receive each composite following the encapsulation die and operable for pulling each composite from the pultrusion unit at a selected speed for each such composite; and
a finishing unit operable for forming each composite into plural load-bearing products.

73. The unit of claim 72, wherein the plural feed units comprise finger dies, and the encapsulation die further comprises a first die unit for feeding molten plastic into a position covering the core, a forming die with a predetermined shaping member, and a cooling unit.

74. The unit of claim 73, wherein the shaping member is one of the group of ellipsoidal, rectangular, and irregular polygonal cross-sectionally shaped member, the encapsulation die further comprising a colorizer unit operable for placing colorizer on the outer plastic layer while still fluid so as to achieve a predetermined color and pattern on a surface of the composite.
